(19) United States
(12) Patent Application Publication
(10) Pub. No.: US 2004/0240130 A1
(43) Pub. Date: Dec. 2, 2004

(54) Semiconductor device having protection device for protecting internal device

(76) Inventor: Nobutaka Kitagawa, Machida-shi (JP)

Correspondence Address: GRAY CARY WARE & FREIDENRICH LLP, 2000 UNIVERSITY AVENUE, E. PALO ALTO, CA, 94303-2248, US

(21) Appl. No.: 10/812,548

(22) Filed: Mar. 29, 2004

(30) Foreign Application Priority Data
Apr. 15, 2003 (JP) 2003-110461

(51) Int. Cl. H02H 9/00

(52) U.S. Cl. 361/56

(57) ABSTRACT

A semiconductor device includes an internal device, and a protection device. The internal device includes a first well region and a first semiconductor element formed in and/or on the first well. The protection device includes a second well region and a second semiconductor element formed in and/or on the second well region. The second well region has a lower impurity concentration than the first well region. The protection device protects the first semiconductor element.

### CROSS-REFERENCE TO RELATED APPLICATIONS

This application is based upon and claims the benefit of priority from prior Japanese Patent Application No. 2003-110461, filed Apr. 15, 2003, the entire contents of which are incorporated herein by reference.

### BACKGROUND OF THE INVENTION

1. Field of the Invention

The present invention relates to a semiconductor device having a protection device for protecting an internal device. For example, it relates to a technique for preventing a semiconductor device from being destroyed by electrostatic discharge (ESD).

2. Description of the Related Art

In general, ESD occurs, for example, when a semiconductor device is carried by a person or machine. When ESD occurs, a potential difference of several hundred to several thousand volts is momentarily applied between two terminals of the device. Semiconductor devices have a very low resistance to ESD. Therefore, they have a protection element for avoiding destruction due to EDS. The protection element discharges static electricity that has accumulated in the semiconductor device, thereby protecting it from destruction due to ESD.

Thyristers have been widely used as protection elements, as is known from, for example, the EOS/ESD Symposium 2002, Session 1A On Chip Protection, “High Holding Current SCRs (HHI-SCR) for ESD Phenomenon and Latch-up Immune IC Operation” written by Marks P. J. Mergens, et al. Further, U.S. patent application Publication No. 2003/0034527 discloses a method for optimizing the impurity concentration of the channel region of a protection element to enhance the performance of the element.

However, in accordance with the recent development of microfabrication of semiconductor devices, conventional thyristers have become insufficient as protectors against ESD. This will now be described in detail with reference to FIG. 1. FIG. 1 is a graph illustrating the voltage-current characteristic of conventional thyristers used as protection elements.

In semiconductor devices, there is a tendency for the thickness of gate oxide films to be reduced in accordance with the development of microfabrication of the devices. This reduces the breakdown voltage BVESD of the internal device to be protected. On the other hand, there is a tendency for the impurity concentration of the well region to increase and for the depth of the well region to become deeper.

In the case of using thyristers as protection elements, the higher the impurity concentration, the lower the current amplification factor hfe and base resistance RB of the bipolar transistors. As a result, the lock-on condition for thyristers, hfe(pnp)×hfe(npn)>1, becomes harder to satisfy. “hfe(pnp)” and “hfe(npn)” indicate the current amplification factors of the pnp transistor and npn transistor incorporated in each thyrister, respectively. At worst, the thyristers may lose the snapback function. In this case, they do not function as protection elements.

Further, if the current amplification factor hfe is reduced, it is necessary to increase the trigger current for locking on the thyrister, and to increase the voltage VCE of the bipolar transistors. As a result, the hold voltage Vh increases. At this time, the resistance (hereinafter referred to as an “ON-resistance) of the thyrister assumed when it is in the lock-on state also increases, whereby the clamp voltage Vclamp increases. Therefore, in some cases, the clamp voltage Vclamp may become higher than the breakdown voltage BVESD of the internal device. This means that the internal device cannot be protected from destruction due to ESD.

Further, if the well region is shallower, the density of the current flowing through the thyrister increases. In this case, a more heat is generated because of the increased current density, therefore the thyrister may be easily destroyed (the breakdown current Ibreak of the thyrister is reduced).

As stated above, in accordance with the development of microfabrication of semiconductor devices, the breakdown voltage of the internal device to be protected is reduced. On the other hand, the performance of the thyrister as a protection device is degraded. Specifically, the hold voltage and clamp voltage increase to thereby make the thyrister inoperable, and further, the thyrister is easily destroyed by heat.

### BRIEF SUMMARY OF THE INVENTION

A semiconductor device according to an aspect of the invention comprises:

an internal device including a first well region and a first semiconductor element formed in and on the first well; and

an internal device including a first well region and a first semiconductor element formed in and/or on the first well; and

a protection device including a second well region and a second semiconductor element formed in and/or on the second well region, the second well region having a lower impurity concentration than the first well region, the protection device protecting the first semiconductor element.

### BRIEF DESCRIPTION OF THE SEVERAL VIEWS OF THE DRAWING

FIG. 1 is a graph illustrating the voltage-current characteristic of a conventional thyrister;

FIG. 2 is a circuit diagram illustrating a semiconductor device according to a first embodiment of the invention;

FIG. 3 is a sectional view illustrating the semiconductor device of the first embodiment;

FIG. 4 is a graph illustrating the impurity concentration profiles of the semiconductor device of the first embodiment, obtained in the depth direction;

FIG. 5 is a graph illustrating the voltage-current characteristic of respective thyristers employed in the semiconductor device of the first embodiment and a conventional semiconductor device;

FIG. 6 is a sectional view illustrating a semiconductor device according to a second embodiment;

FIG. 7 is a graph illustrating the impurity concentration profiles of the semiconductor device of the second embodiment, obtained in the depth direction;

FIG. 8 is a graph illustrating the voltage-current characteristic of respective thyristers employed in the semiconductor device of the second embodiment and a conventional semiconductor device;

FIG. 9 is a sectional view illustrating a semiconductor device according to a third embodiment;

FIG. 10 is a graph illustrating the impurity concentration profiles of the semiconductor device of the third embodiment, obtained in the depth direction;

FIG. 11 is a graph illustrating the voltage-current characteristic of respective thyristers employed in the semiconductor device of the third embodiment and a conventional semiconductor device;

FIG. 12 is a circuit diagram illustrating a semiconductor device according to a fourth embodiment of the invention;

FIG. 13 is a sectional view illustrating the semiconductor device of the fourth embodiment;

FIG. 14 is a graph illustrating the voltage-current characteristic of respective thyristers employed in the semiconductor device of the fourth embodiment and a conventional semiconductor device;

FIG. 15 is a sectional view illustrating a semiconductor device according to a fifth or sixth embodiment;

FIG. 16 is a graph illustrating the voltage-current characteristic of respective thyristers employed in the semiconductor devices of the fourth to sixth embodiments and a conventional semiconductor device;

FIG. 17 is a circuit diagram illustrating a semiconductor device according to a seventh embodiment of the invention;

FIG. 18 is a sectional view illustrating the semiconductor device of the seventh embodiment;

FIG. 19 is a graph illustrating the voltage-current characteristic of respective MOS transistors employed in the semiconductor device of the seventh embodiment and a conventional semiconductor device;

FIG. 20 is a sectional view illustrating a semiconductor device according to an eighth or ninth embodiment;

FIG. 21 is a block diagram illustrating a semiconductor device according to a first modification of the first to ninth embodiments; and

FIG. 22 is a block diagram illustrating a semiconductor device according to a second modification of the first to ninth embodiments.

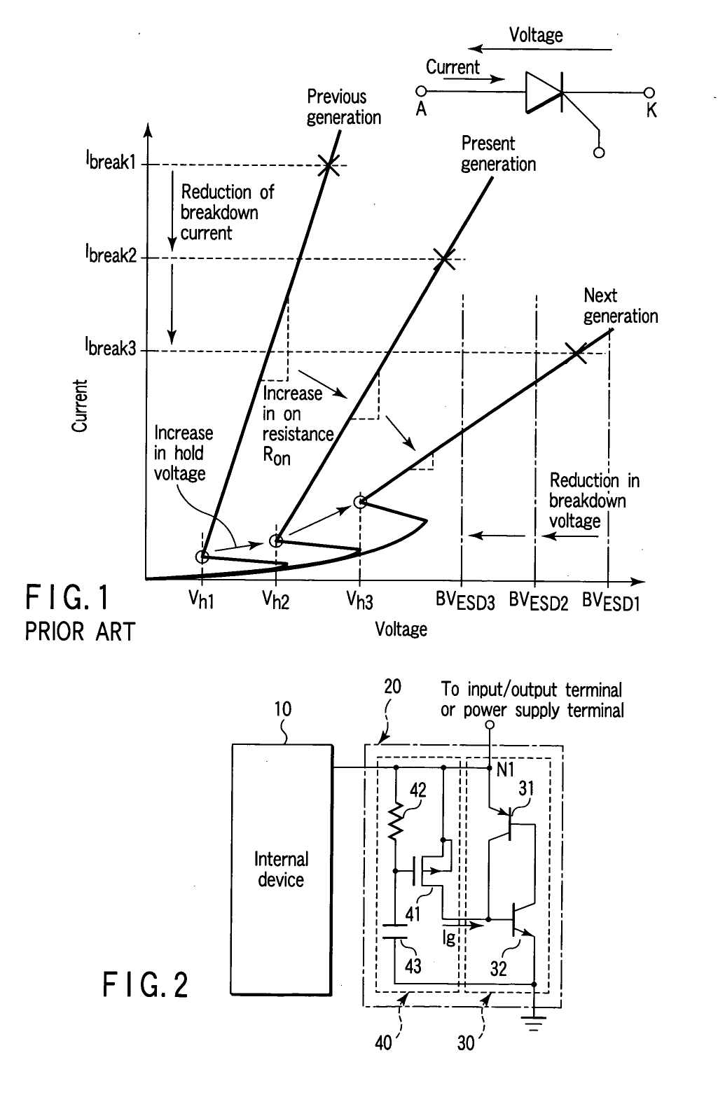

### DETAILED DESCRIPTION OF THE INVENTION

Referring first to FIG. 2, a semiconductor device according to a first embodiment of the invention will be described. FIG. 2 is a circuit diagram illustrating the semiconductor device of the first embodiment.

As shown, the semiconductor device comprises an internal device 10 and protection device 20. The protection device 20 is used to protect the internal device 10 from destruction due to ESD, and located between the internal device 10 and the input/output terminal or power supply terminal of the semiconductor device. The protection device 20 has a thyrister 30 and trigger circuit 40. A description will now be given, assuming that the protection device 20 is connected to the input/output terminal.

The thyrister 30 comprises a pnp bipolar transistor 31 and npn bipolar transistor 32. The bipolar transistor 31 has an emitter connected to a node N1 connected to the input/output terminal, a base connected to the collector of the bipolar transistor 32, and a collector connected to the base of the bipolar transistor 32. The emitter of the bipolar transistor 32 is grounded. The emitter of the bipolar transistor 31 serves as the anode terminal of the thyrister, the emitter of the bipolar transistor 32 serves as the cathode terminal of the thyrister and the connection node between the collector of the transistor 31 and the base of the transistor 32 serves as the trigger terminal of the thyrister.

The trigger circuit 40 comprises a p-channel MOS transistor 41, resistor 42 and capacitor 43. The p-channel MOS transistor 41 has a source connected to the node N1, and a drain connected to the trigger terminal of the thyrister. The resistor 42 and capacitor 43 are connected in series between the node N1 and the ground potential. The connection node of the resistor 42 and capacitor 43 is connected to the gate of the MOS transistor 41.

In the protection device 20 formed as above, when a large current flows into the semiconductor device from the input/output terminal because of, for example, occurrence of static electricity, the thyrister 30 guides the current to the ground, thereby protecting the internal device 10 from destruction due to ESD.

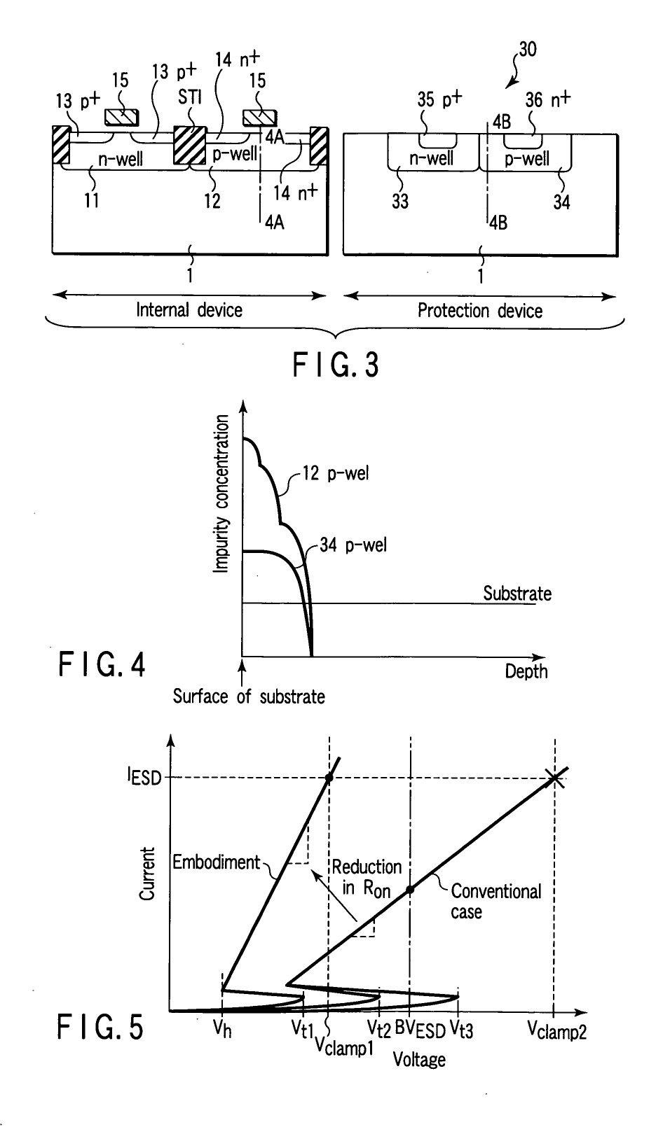

FIG. 3 is a sectional view illustrating the internal device 10 and protection device 20 (in particular, the thyrister 30) shown in FIG. 2.

Firstly, the internal device 10 will be described. As shown, the internal device 10 includes a CMOS buffer circuit. Specifically, an element isolation region STI is formed in the surface of a semiconductor substrate 1. An n-type well region 11 and p-type well region 12 are formed in the surface portions of the substrate 1 surrounded by the element isolation region STI. In the surface of the n-type well region 11, p⁺-type impurity diffusion layers 13 serving as source and drain regions are formed separate from each other. Similarly, in the surface of the p-type well region 12, n⁺-type impurity diffusion layers 14 serving as source and drain regions are formed separate from each other. Respective gate electrodes 15 are formed on the substrate 1 between the p⁺-type impurity diffusion layers 13 and between the n⁺-type impurity diffusion layers 14, respectively, with a gate insulation film (not shown) interposed. Thus, a p-channel MOS transistor is formed in and on the n-type well region 11, while an n-channel MOS transistor is formed in and on the p-type well region 12.

The structure of the thyrister 30 will be described.

As shown in FIG. 3, an n-type well region 33 and p-type well region 34 are formed in contact with each other in the surface of the semiconductor substrate 1. The n-type well region 33 and p-type well region 34 have the same depth as the n-type well region 11 and p-type well region 12 of the internal device 10. A p⁺-type impurity diffusion layer 35 and n⁺-type impurity diffusion layer 36 are formed in the surfaces of the n-type well region 33 and p-type well region 34, respectively. The pnp bipolar transistor 31 includes the p⁺-type impurity diffusion layer 35 serving as its emitter, the n-type well region 33 serving as its base, and the p-type well region 34 serving as its collector. Further, the npn bipolar transistor 32 includes the n⁺-type impurity diffusion layer 36 serving as its emitter, the p-type well region 34 serving as its base, and the n-type well region 33 serving as its collector.

FIG. 4 is a graph illustrating the impurity concentration profiles of the well regions 12 and 34 formed in the internal device 10 and protection device 20, respectively. The abscissa indicates the depth from the surface of the semiconductor substrate, while the ordinate indicates the impurity concentration. More specifically, FIG. 4 shows the concentration profiles of the well region 12 of the internal device 10 in the direction of line 4A-4A of FIG. 3, and that of the well region 34 of the protection device 20 in the direction of line 4B-4B of FIG. 3.

As shown in FIG. 4, the impurity concentration of the well region 34 in the protection device 20 is lower than that of the well region 12 in the internal device 10. More specifically, the concentration of the p-type impurity included in the well region 34 is lower than the concentration of the p-type impurity included in the well region 12. This can be said of the entire well regions 12 and 34 in the depth direction. In other words, this relationship is established both in surface portions of the well regions 12 and 34, and in deeper portions thereof. The relationship is also established between the well regions 11 and 33. The impurity concentration of the well region 33 is lower than that of the well region 11. This can be said of the entire well regions 11 and 33 in the depth direction. The relationship may be established between the well regions 11 and 34 and between the well regions 12 and 33.

Referring then to FIG. 5, the operation of the protection device 20 formed as above will be described. FIG. 5 is a graph illustrating the voltage-current characteristic of the thyrister 30 according to the embodiment and that of a conventional thyrister.

Assume that a large current has flown via the input/output terminal because of, for example, occurrence of static electricity. At this time, the capacitor 43 of the trigger circuit 40 applies a bias voltage to the gate of the MOS transistor 41. In other words, the gate potential of the MOS transistor 41 is set at the ground potential GND. Generally, a static electricity surge, for example, input through the input/output terminal is an instantaneous pulse. Accordingly, the capacitor 43 cannot sufficiently charge the electricity guided thereto from the resistor 42, therefore the gate potential of the MOS transistor does not increase. On the other hand, the potential at the node N1, i.e., the source potential of the MOS transistor 41 is increased by the surge. As a result, a gate bias voltage is applied to the MOS transistor 41 to thereby shift it to the ON state. If the node N1 is connected to the power supply, the MOS transistor 41 does not turn on. This is because the voltage supplied from the power supply gradually increases. In this case, since the capacitor 43 is sufficiently charged, the gate potential of the MOS transistor 41 increases and the transistor 41 keeps in the OFF state.

As a result, the MOS transistor 41 supplies a current Ig to the trigger terminal of the thyrister 30. When the potential at the node N1 exceeds a trigger voltage Vt1, the pn junction formed of the n-type well 33 and p-type well 34 is broken down. As a result, the thyrister does not show a forward interruption state (i.e., assumes a lock-on state), thereby guiding an ESD current IESD from the anode (node N1) to the cathode (ground). At this time, the node N1 is at a clamp voltage Vclamp1. Of course, the trigger voltage Vt1, at which snapback occurs, and the clamp voltage Vclamp1 are lower than the breakdown voltage BVESD of the semiconductor element(s) in the internal device 10.

In the semiconductor device of the embodiment, the protection device can effectively protect the internal device from ESD. This will be described in detail, referring to FIG. 5 that shows the first embodiment and a conventional case as a comparative.

As seen from FIG. 5, the trigger voltage Vt2 and clamp voltage Vclamp2 of the conventional thyrister are high. Therefore, there was a case where when an ESD current IESD flew into the protection device through the input/output terminal due to occurrence of static electricity, even if the thyrister locked on, the voltage between the terminals of the thyrister exceeded the breakdown voltage BVESD of the internal device before it reached the clamp voltage Vclamp2. In this case, even if the thyrister locks on, the internal device is destroyed. Further, the thyrister is very hard to lock on, and the trigger voltage Vt3 may exceed the breakdown voltage BVESD. In this case, the internal device is destroyed before the thyrister locks on.

However, in the embodiment, the impurity concentration of the well regions 33 and 34 in the protection device 20 are set lower than that of the well regions 11 and 12 in the internal device 10. Further, this relationship is established not only in shallower portions of the well regions 11, 12, 33 and 34, but also in their deeper portions. Therefore, the current amplification factors hfe(pnp) and hfe(npn) of the pnp bipolar transistor 31 and npn bipolar transistor 32 are higher than in the conventional case. This enables the thyrister 30 to easily satisfy the lock-on condition, hfe(pnp)×hfe(npn)>1. Further, like the current amplification factors, the base resistances RB of the pnp bipolar transistor 31 and npn bipolar transistor 32 are in inverse proportion to the impurity concentrations ND and NA of the well regions 33 and 34 (RB=1/impurity concentration). Therefore, the embodiment exhibits higher base resistances RB than the conventional case. Furthermore, in the embodiment, the trigger circuit 40 supplies a gate current Ig to the trigger terminal of the thyrister 30. By virtue of the structure in which the current amplification factors hfe(pnp) and hfe(npn) are high, the base resistances RB are high, and the trigger current Ig is supplied, the thyrister 30 locks on at a trigger voltage Vt1 lower than the conventional one Vt2, as shown in FIG. 5.

Yet further, since the impurity concentrations are kept lower in the entire well regions 33 and 34 than in the entire well region 33 and 34, respectively, in the depth direction, the minimum voltage for maintaining the forward conductive state of the thyrister 30 (minimum operation maintenance voltage=hold voltage Vh) is low. This is because the current amplification factors hfe(pnp) and hfe(npn) of the pnp bipolar transistor 31 and npn bipolar transistor 32 are high. Since the current amplification factors are high, a higher collector current IC can be flown with a lower base current IB than in the conventional case, and the voltage VCE between the collector and emitter can be set low. This means that the voltage between the anode and cathode for maintaining the forward conductive state of the thyrister 30 can be set lower than in the conventional case. In other words, the hold voltage Vh can be set lower than in the conventional case.

Also, the resistance Ron of the thyrister 30, assumed when the thyrister 30 is in the ON state (this resistance will hereinafter be referred to as an “ON-resistance”), can be reduced by reducing the impurity concentrations of the entire well regions 33 and 34 in the depth direction. As shown in FIG. 5, the inclination of the line indicating the lock-on state is larger than in the conventional case, which means that the ratio of an increase in current to an increase in voltage is higher than in the conventional case.

As described above, since the hold voltage Vh and ON-resistance of the thyrister 30 are lower than in the conventional case, the required clamp voltage Vclamp1 is reduced.

In the protection device of the first embodiment, the trigger voltage Vt1 and clamp voltage Vclamp1 are low. Therefore, even if the resistance of the internal device 10 to ESD is reduced in accordance with the development of microfabrication of semiconductor devices, the internal device 10 can be sufficiently protected from ESD.

Moreover, the structure of the first embodiment enables the thyrister 30 to be made compact. In general, a certain rating is imparted to the thyrister 30 as a protection element. This rating means that the thyrister 30 can protect the internal device if the ESD current does not exceed a predetermined value. In the thyrister of the embodiment, the clamp voltage occurring when a predetermined ESD current flows is lower than in the conventional case, therefore the power occurring at this time is smaller than in the conventional case. Accordingly, the size of the thyrister 30 can be reduced, which contributes to the reduction of the chip size.

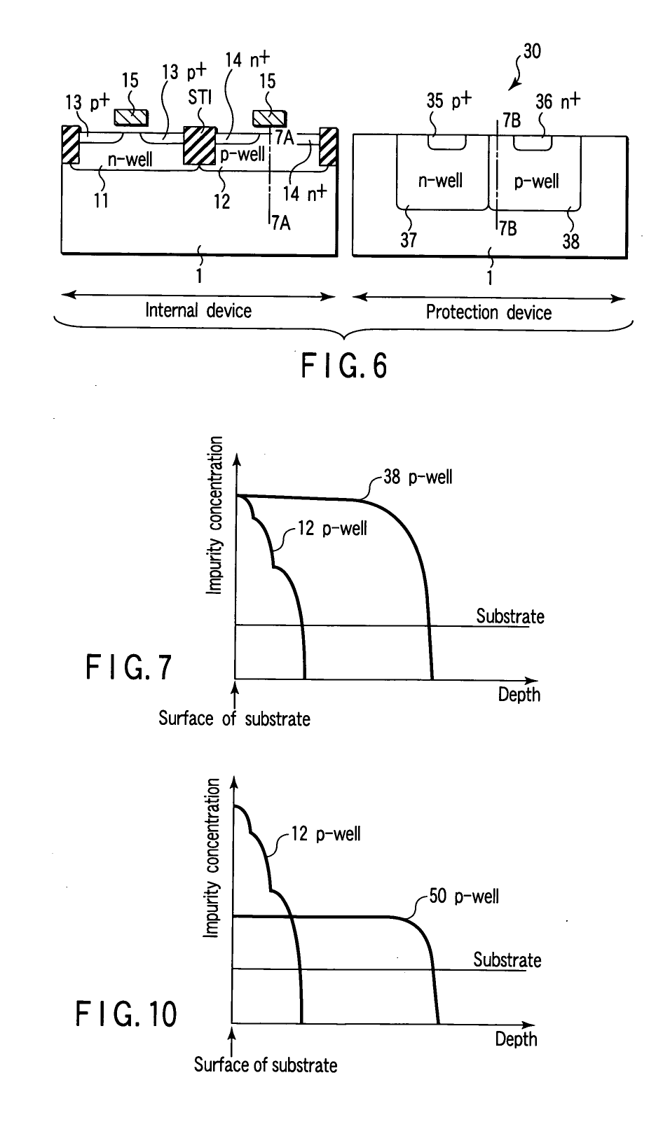

Referring to FIG. 6, a semiconductor device according to a second embodiment will be described. FIG. 6 is a sectional view illustrating the internal device 10 and protection device 20 (in particular, thyrister) according to the second embodiment. As seen from FIG. 6, the second embodiment differs from the first embodiment only in that, in the former, the well regions in the protection device 20 are deeper than those in the internal device 10, with their impurity concentrations unchanged. Since the internal device 10 in the second embodiment has substantially the same structure as the internal device 10 in the first embodiment, only the protection device 20 (i.e., thyrister 30) will be described.

As shown in FIG. 6, the thyrister 30 is formed such that an n-type well region 37 and p-type well region 38 are formed in contact with each other in the surface of the semiconductor substrate 1. The n-type well region 37 and p-type well region 38 are deeper than the n-type well region 11 and p-type well region 12 of the internal device 10. A p⁺-type impurity diffusion layer 35 and n⁺-type impurity diffusion layer 36 are formed in the surfaces of the n-type well region 37 and p-type well region 38, respectively. The pnp bipolar transistor 31 includes the p⁺-type impurity diffusion layer 35 serving as its emitter, the n-type well region 37 serving as its base, and the p-type well region 38 serving as its collector. Further, the npn bipolar transistor 32 includes the n⁺-type impurity diffusion layer 36 serving as its emitter, the p-type well region 38 serving as its base, and the n-type well region 37 serving as its collector.

FIG. 7 is a graph illustrating the impurity concentration profiles of the well regions 12 and 38 provided in the internal device 10 and protection device 20, respectively. More specifically, FIG. 7 shows the concentration profile of the well region 12 of the internal device 10 in the direction of line 7A-7A of FIG. 6, and that of the well region 38 of the protection device 20 in the direction of line 7B-7B of FIG. 6.

As shown in FIG. 7, the impurity concentration of the well region 38 in the protection device 20 is substantially the same as that of the well region 12 in the internal device 10. However, the well region 38 is deeper than the well region 12. That is, the well region 38 has a greater depth than the well region 12. This relationship is established between the well regions 11 and 37. Further, the relationship may be established between the well regions 11 and 38 and between the well regions 12 and 37.

The protection device 20 of the second embodiment operates in the same manner as the protection device of the first embodiment. Therefore, no description is given thereof.

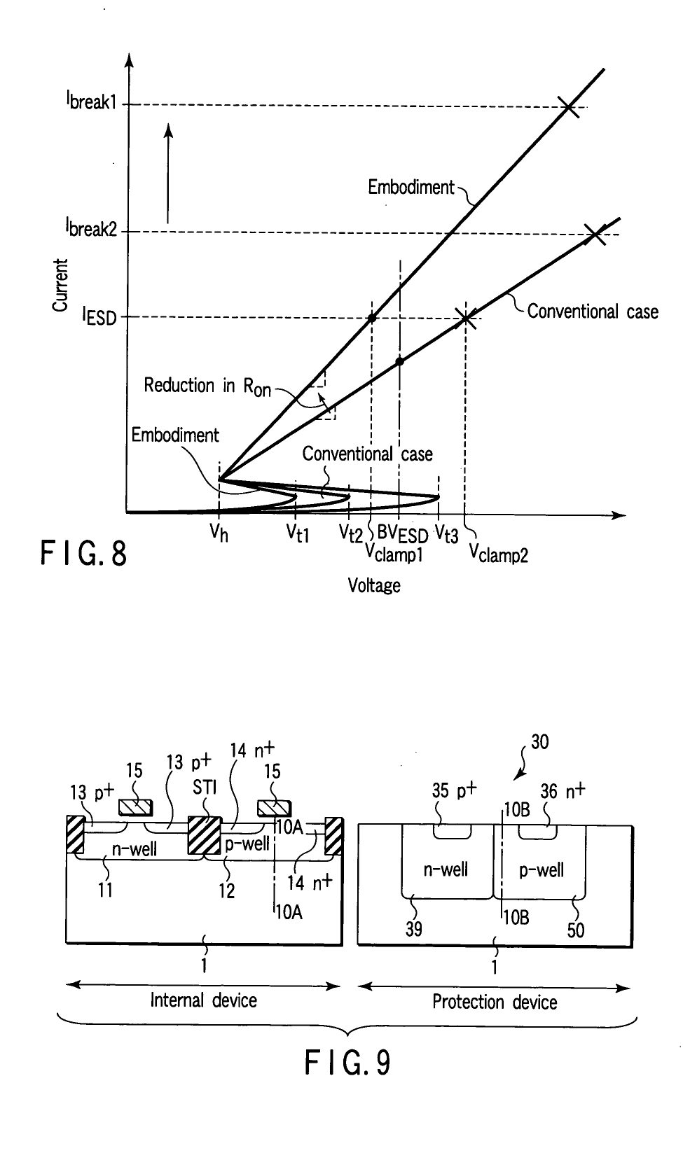

In the semiconductor device of the second embodiment, the protection device can effectively protect the internal device from ESD. This will be described, referring to FIG. 8 that shows the second embodiment and a conventional case as a comparative. FIG. 8 is a graph illustrating the voltage-current characteristic of the thyrister of the second embodiment and a conventional thyrister.

The characteristic of the conventional thyrister is explained in the first embodiment. In the second embodiment, the impurity concentration of the well region 37 of the protection device 20 is substantially the same as that of the well region 11 of the internal device 10. Similarly, the impurity concentration of the well region 38 of the protection device 20 is substantially the same as that of the well region 12 of the internal device 10. Accordingly, the current amplification factors hfe(pnp) and hfe(npn) of the pnp bipolar transistor 31 and npn bipolar transistor 32 are substantially the same as in the conventional case. That is, the hold voltage Vh of the thyrister is substantially the same as that of the conventional case. However, the well regions 37 and 38 are deeper than in the conventional case. In other words, the regions in the pnp bipolar transistor 31 and npn bipolar transistor 32, in which the collector current IC flows, have larger cross sections. Therefore, the ON-resistance Ron of the thyrister 30 is reduced, thereby reducing the clamp voltage Vclamp1.

Further, the trigger circuit 40 supplies a gate current Ig to the trigger terminal of the thyrister 30. By virtue of this, the thyrister 30 locks on at a trigger voltage Vt1 lower than the conventional one Vt2.

As described above, in the thyrister 30 of the second embodiment, the clamp voltage Vclamp1 and trigger voltage Vt1 can be reduced, compared to the conventional case. As a result, like the first embodiment, the internal device 10 can be sufficiently protected from ESD even if its resistance to ESD is reduced.

Further, the second embodiment provides the effect of enhancing the resistance of the thyrister to the breakdown current. On the other hand, in the conventional structure, the well regions become shallower in accordance with the development of microfabrication of semiconductor devices. As a result, the current flowing per unit volume increases, and the density of the heat generated by the current accordingly increases, thereby reducing the breakdown current (Ibreak2 in FIG. 8). In other words, the thyrister becomes to be easily destroyed.

In the second embodiment, however, the well regions 37 and 38 of the protection device 20 are deeper than the well regions 11 and 12 of the internal device 10. The collector current (hfe(npn)×Ig) of the npn bipolar transistor 32 (the base current of the pnp bipolar transistor 31) flows into the n-type well region 37. Similarly, the collector current (hfe(pnp)×hfe(npn)×Ig) of the pnp bipolar transistor 31 (the base current of the npn bipolar transistor 32) flows into the p-type well region 38. Since the well regions 37 and 38 are deeper than the conventional case, the collector current density per unit volume is lower, therefore the amount of the heat generated is smaller. This being so, concentration of heat in the surface of the semiconductor substrate is suppressed, and hence the thyrister can be effectively protected from destruction due to the heat, compared to the conventional case. In other words, the thyrister can stand a larger current.

In addition, like the first embodiment, the thyrister 30 of the second embodiment can be made more compact than the conventional one, which contributes to the reduction of the chip size.

A semiconductor device according to a third embodiment will be described. This embodiment is obtained by combining the first and second embodiments. Since the semiconductor device of the third embodiment has the same circuit structure as the first embodiment shown in FIG. 2, no description is given thereof. FIG. 9 is a sectional view of the semiconductor device of the third embodiment, illustrating an internal device 10 and a protection device 20 (in particular, the thyrister 30). Since the internal device 10 in the third embodiment has substantially the same structure as that in the first embodiment, only the thyrister 30 will be described.

As shown in FIG. 9, the thyrister 30 is formed such that an n-type well region 39 and p-type well region 50 are formed in contact with each other in the surface of the semiconductor substrate 1. The n-type well region 39 and p-type well region 50 are deeper than the n-type well region 11 and p-type well region 12 of the internal device 10. Further, the region 39 has a lower impurity concentration than the region 11, while the region 50 has a lower impurity concentration than the region 12. A p⁺-type impurity diffusion layer 35 and n⁺-type impurity diffusion layer 36 are formed in the surfaces of the n-type well region 39 and p-type well region 50, respectively. The pnp bipolar transistor 31 includes the p⁺-type impurity diffusion layer 35 serving as its emitter, the n-type well region 39 serving as its base, and the p-type well region 50 serving as its collector. Further, the npn bipolar transistor 32 includes the n⁺-type impurity diffusion layer 36 serving as its emitter, the p-type well region 50 serving as its base, and the n-type well region 39 serving as its collector.

FIG. 10 is a graph illustrating the impurity concentration profiles of the well regions 12 and 50 provided in the internal device 10 and protection device 20, respectively. More specifically, FIG. 10 shows the concentration profile of the well region 12 of the internal device 10 in the direction of line 10A-10A of FIG. 9, and that of the well region 50 of the protection device 20 in the direction of line 10B-10B of FIG. 9.

As shown in FIG. 10, the impurity concentration of the well region 50 in the protection device 20 is lower than that of the well region 12 in the internal device 10. More specifically, the concentration of the p-type impurity included in the well region 50 is lower than the-concentration of the p-type impurity included in the well region 12. This can be said of the entire well regions 12 and 50 in the depth direction. In other words, this relationship is established both in surface portions of the well regions 12 and 50, and in deeper portions thereof. Further, the well region 50 is deeper than the well region 12. The relationship is also established between the well regions 11 and 39. The relationship may be established between the well regions 11 and 50 and between the well regions 12 and 39.

The protection device 20 of the third embodiment operates in the same manner as the protection device of the first embodiment. Therefore, no description is given thereof.

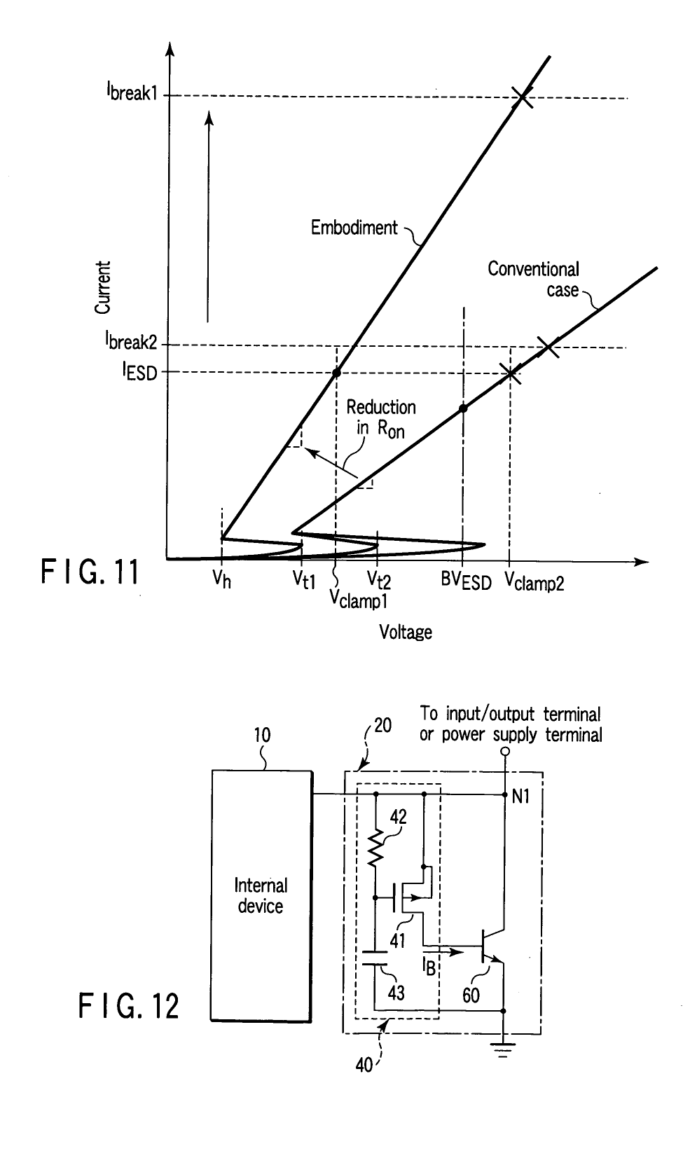

The semiconductor device of the third embodiment can provide both the advantages of the first and second embodiments. Specifically, as indicated by the voltage-current characteristic of the thyrister of the third embodiment and that of the conventional thyrister shown in FIG. 11, the trigger voltage and clamp voltage of the thyrister of the third embodiment can be set lower than those of the conventional thyrister. Accordingly, in the third embodiment, the internal device 10 can be more effectively protected from ESD. Further, generation of heat by the thyrister can be suppressed, therefore the thyrister can be protected from damage due to the heat.

Furthermore, like the first embodiment, the size of the thyrister 30 can be reduced compared to the conventional case, which contributes to the reduction of the chip size.

Referring to FIG. 12, a semiconductor device according to a fourth embodiment will be described. FIG. 12 is a circuit diagram illustrating the semiconductor device of the fourth embodiment. The fourth embodiment differs from the first embodiment in that, in the former, the thyrister 30 is replaced with a bipolar transistor.

As shown in FIG. 12, the semiconductor device comprises an internal device 10 and protection device 20. The protection device 20 has an npn bipolar transistor 60 and trigger circuit 40. Since the trigger circuit 40 has the same structure as that employed in the first embodiment, no description is given thereof. The bipolar transistor 60 has a base connected to the drain of a MOS transistor 41 incorporated in the trigger circuit 40, an emitter grounded and a collector connected to a node N1.

When a large current occurring due to, for example, static electricity flows into the semiconductor device from the input/output terminal or power supply terminal, the protection device 20 protects the internal device 10 from ESD by guiding the current to the ground via the bipolar transistor 60.

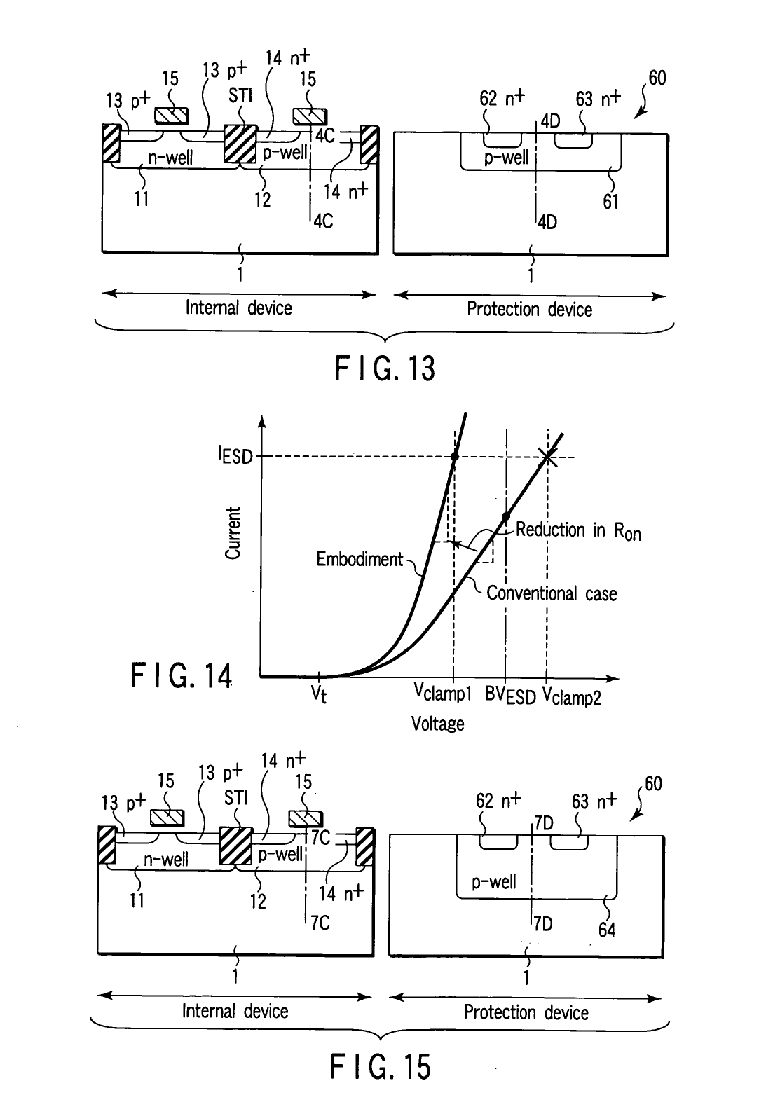

FIG. 13 is a sectional view illustrating the internal device 10 and protection device 20 (in particular, the bipolar transistor 60) shown in FIG. 12. Since the internal device 10 has the same structure as that of the first embodiment, no description is given thereof.

As shown in FIG. 13, in the protection device 20, a p-type well region 61 is formed in the surface of the semiconductor substrate 1. The well region 61 has the same depth as the n-type well region 11 and p-type well region 12 of the internal device 10. N⁺-type impurity diffusion layers 62 and 63 separate from each other are formed in the surface of the p-type well region 61. The npn bipolar transistor 60 includes the n⁺-type impurity diffusion layer 62 serving as its emitter, the p-type well region 61 serving as its base, and the n⁺-type impurity diffusion layer 63 serving as its collector.

The impurity concentration profile of the p-type well region 12 obtained in the direction of line 4C-4C in FIG. 13, and that of the p-type well region 61 obtained in the direction of line 4D-4D in FIG. 13 are similar to those of FIG. 4 related to the first embodiment. Specifically, the impurity concentration of the well region 61 incorporated in the protection device 20 is lower than that of the well region 12 incorporated in the internal device 10. More specifically, the concentration of the p-type impurity included in the well region 61 is lower than the concentration of the p-type impurity included in the well region 12. This can be said of the entire well regions 12 and 61 in the depth direction. In other words, this relationship is established both in surface portions of the well regions 12 and 61, and in deeper portions thereof. The relationship may be established between the well regions 11 and 61.

Referring to FIG. 14, the operation of the protection device 20 of the fourth embodiment will be described. FIG. 14 is a graph illustrating the voltage (VCE)−current (IC) characteristic of the protection device shown in FIG. 12.

When a large current flows into the semiconductor device from the input/output terminal, the capacitor 43 applies a bias voltage to the gate of the MOS transistor 41. Accordingly, the MOS transistor 41 is turned on, thereby supplying a base current IB to the base of the bipolar transistor 60. Upon receiving the base current IB, the bipolar transistor 60 starts to flow a collector current, thereby guiding an ESD current IESD from the collector (node N1) to the emitter (ground). At this time, the node N1 is at the clamp voltage Vclamp1. Of course, the clamp voltage Vclamp1 is lower than the breakdown voltage BVESD of the semiconductor element(s) in the internal device 10.

In the semiconductor device of the fourth embodiment, the protection device can effectively protect the internal device from ESD. This will be described in detail, referring to FIG. 14 that shows the fourth embodiment and a conventional case as a comparative.

As seen from FIG. 14, the clamp voltage Vclamp2 of a conventional bipolar transistor is high. This is because the impurity concentration of the well region is high, and the current amplification factor hfe of the bipolar transistor is low, as explained in the section “Description of the Related Art”. This being so, when an ESD current IESD flows into the semiconductor device from the input/output terminal, even if the bipolar transistor operates normally, the voltage between the collector and emitter of the bipolar transistor may well exceed the breakdown voltage BVESD of the internal device before it reaches the clamp voltage Vclamp2. This means that the protection function of the bipolar transistor is insufficient, therefore the internal device will be damaged by ESD.

On the other hand, in the fourth embodiment, the impurity concentration of the well region 61 in the protection device 20 is lower than those of the well regions 11 and 12 in the internal device 10. This relationship is established not only in shallower portions of the well regions but also in their deeper portions. Therefore, the current amplification factor hfe of the bipolar transistor 60 is higher than that of the conventional one. Therefore, with the same base current, a larger collector current can be flown than in the conventional case. Further, the resistance Ron (i.e., ON-resistance) of the bipolar transistor, assumed when the bipolar transistor is in the ON state, is lower than in the conventional case. In other words, an increase in current relative to an increase in voltage is greater than in the conventional case.

Since the current amplification factor hfe of the bipolar transistor 60 is increased and the ON-resistance Ron is reduced, compared to the conventional case, the clamp voltage Vclamp1 is lower than the conventional clamp voltage Vclamp2.

As described above, in the protection device of the fourth embodiment, the clamp voltage Vclamp1 of the bipolar transistor is low. Therefore, even if the resistance of the internal device 10 to ESD is reduced because of the development of microfabrication of semiconductor devices, the protection device can sufficiently protect the internal device 10 from ESD.

In addition, for the same reason as stated in the first embodiment, the power occurring in the bipolar transistor 60 can be reduced. This enables the bipolar transistor 60 to be made smaller than the conventional one, and hence enables the chip size to be reduced.

A semiconductor device according to a fifth embodiment will be described. This embodiment differs from the fourth embodiment in that, in the former, the well regions in the protection device 20 are deeper than those in the internal device 10, with their impurity concentrations unchanged. The semiconductor device of the fifth embodiment has substantially the same circuit structure as the fourth embodiment shown in FIG. 12, therefore no description is given thereof. FIG. 15 is a sectional view of the semiconductor device of the fifth embodiment, illustrating the internal device 10 and protection device 20 (in particular, the bipolar transistor 60). The internal device 10 of the fifth embodiment has substantially the same structure as the internal device 10 of the fourth embodiment. Therefore, only the bipolar transistor 60 will be described.

As shown in FIG. 15, in the protection device 20 of the fifth embodiment, a p-type well region 64 is formed in the surface of the semiconductor substrate 1. The well region 64 is formed deeper than the n-type well region 11 and p-type well region 12 of the internal device 10. N⁺-type impurity diffusion layers 62 and 63 separate from each other are formed in the surface of the p-type well region 64. The npn bipolar transistor 60 includes the n⁺-type impurity diffusion layer 62 serving as its emitter, the p-type well region 64 serving as its base, and the n⁺-type impurity diffusion layer 63 serving as its collector.

The impurity concentration profile of the p-type well region 12 obtained in the direction of line 7C-7C in FIG. 15, and that of the p-type well region 64 obtained in the direction of line 7D-7D in FIG. 15 are similar to those of FIG. 7 related to the second embodiment. Specifically, the well region 64 incorporated in the protection device 20 has substantially the same impurity concentration as the well region 12 incorporated in the internal device 10, and is deeper than the well region 12. This relationship may be established between the well regions 11 and 64.

The protection device 20 of the fifth embodiment operates in the same manner as the protection device of the fourth embodiment. Therefore, no description is given thereof.

The semiconductor device of the fifth embodiment can provide the same advantage as the fourth embodiment. This will be described referring to FIG. 14. FIG. 14 shows the voltage-current characteristic of the bipolar transistor 60 of the fourth embodiment. The bipolar transistor 60 of the fifth embodiment exhibits a similar characteristic.

In the fifth embodiment, the well region 64 is deeper than the conventional one, i.e., the region into which the collector current IC of the bipolar transistor 60 flows has a larger cross section. Accordingly, the ON-resistance Ron of the bipolar transistor 60 is lower than the conventional one. As a result, the clamp voltage Vclamp1 is reduced as in the fourth embodiment. Therefore, even if the resistance of the internal device 10 to ESD is reduced in accordance with the development of microfabrication of semiconductor devices, the internal device 10 can be sufficiently protected from ESD.

Further, the size of the bipolar transistor 60 can be reduced as in the fourth embodiment, which contributes to the reduction of the chip size.

A semiconductor device according to a sixth embodiment will be described. This embodiment is obtained by combining the fourth and fifth embodiments. Since the semiconductor device of the sixth embodiment has the same circuit structure as the fourth embodiment shown in FIG. 12, no description is given thereof. Further, the semiconductor device of the sixth embodiment has the same cross section as the fifth embodiment shown in FIG. 15, and the impurity concentration profiles of the well regions provided in the internal device 10 and protection device 20 are similar to those of FIG. 10. The operation of the protection device 20 is also similar to that of the protection device 20 employed in the fourth embodiment.

In the sixth embodiment, the impurity concentration of the well region 64 of the protection device 20 is set lower than those of the well regions 11 and 12 of the internal device 10. Accordingly, the current amplification factor hfe of the bipolar transistor 60 is higher than in the conventional case. Further, the ON-resistance Ron is lower than in the conventional case.

Furthermore, the well region 64 is deeper than in the conventional case, i.e., the region into which the collector current IC of the bipolar transistor 60 flows has a larger cross section. Accordingly, the ON-resistance Ron of the bipolar transistor 60 is further reduced.

As a result, the clamp voltage Vclamp1 is reduced as in the fourth and fifth embodiments. Therefore, even if the resistance of the internal device 10 to ESD is reduced in accordance with the development of microfabrication of semiconductor devices, the internal device 10 can be sufficiently protected from ESD. Also, the size of the bipolar transistor 60 can be reduced as in the fourth embodiment, which contributes to the reduction of the chip size.

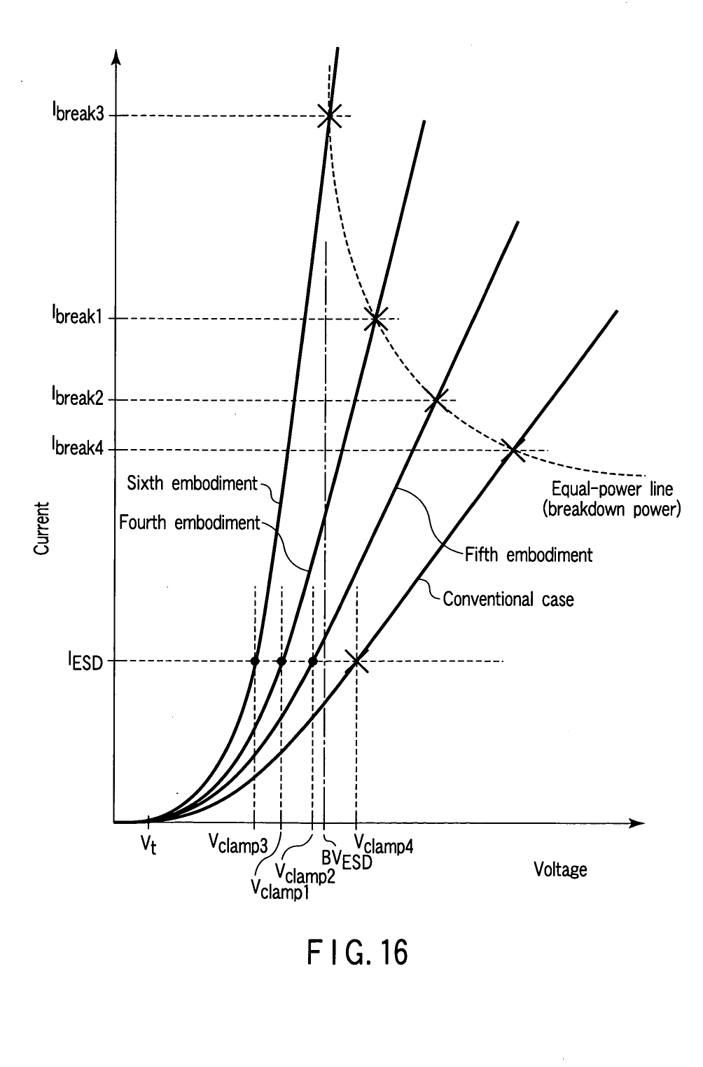

FIG. 16 shows the voltage (VCE)−current (IC) characteristic of the protection device shown in FIG. 12, useful in explaining the respective cases of using the bipolar transistors 60 of the fourth to sixth embodiments and a conventional bipolar transistor. It is understood from FIG. 16 that, in the cases of using the bipolar transistors 60 of the fourth to sixth embodiments, the voltage VCE (clamp voltage) generated when the same ESD current IESD flows is lower than in the case of using the conventional bipolar transistor. This means that, in the present embodiments, even if the resistance of the internal device to ESD is lowered, the internal device can be effectively protected therefrom.

Further, the critical current (breakdown current) at or over which the bipolar transistor is destroyed is increased. The destruction of the bipolar transistor depends upon the density of power generated therein. In the embodiments of the invention, a larger current flows with the same voltage than in the conventional case. Accordingly, assuming that the bipolar transistor is destroyed at the equal power line shown in FIG. 16, the breakdown current Ibreak is larger than in the conventional case. In other words, the bipolar transistors according to the fourth to sixth embodiments can stand a greater ESD than the conventional one. Thus, the protection devices of the embodiments can exhibit an excellent protection function.

Furthermore, the current amplification factor hfe of each of the bipolar transistors of the fourth to sixth embodiments is higher and the ON-resistance Ron is lower than in the conventional case. Therefore, the bipolar transistor as a protection element may be used as an element incorporated in the internal device. In this case, the bipolar transistor according to each of the fourth to sixth embodiments can be used as a high-performance semiconductor element.

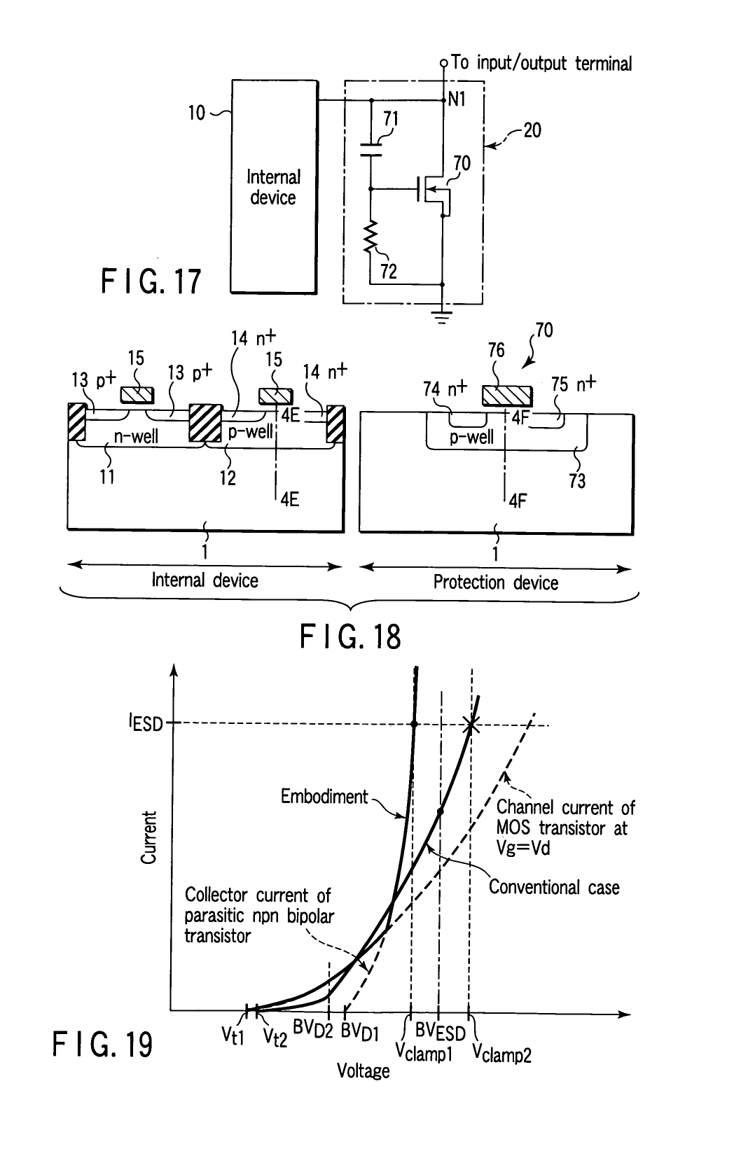

Referring to FIG. 17, a semiconductor device according to a seventh embodiment will be described. FIG. 17 is a circuit diagram illustrating the semiconductor device of the seventh embodiment.

As shown, the semiconductor device of the seventh embodiment comprises an internal device 10 and protection device 20. The protection device 20 is used to protect the internal device 10 from destruction due to ESD, and located between the internal device 10 and the input/output terminal of the semiconductor device. The protection device 20 has an n-channel MOS transistor 70, capacitor 71 and resistor 72.

The MOS transistor 70 has a source grounded, and a drain connected to a node N1 that is connected to the input/output terminal. The capacitor 71 and resistor 72 are connected in series between the node N1 and ground potential. The connection node of the capacitor 71 and resistor 72 is connected to the gate of the MOS transistor 70. The MOS transistor 70 is larger than the MOS transistor incorporated in the internal device 10, since it is required to pass an ESD current therethrough. More specifically, the channel length and width of the transistor 70 are made greater than those of the latter so that the transistor 70 can supply a larger current.

In the protection device 20 formed as above, when a large current flows into the semiconductor device from the input/output terminal because of, for example, occurrence of static electricity, the MOS transistor 70 guides the current to the ground via its current path (the drain to the source), thereby protecting the internal device 10 from destruction due to ESD.

FIG. 18 is a sectional view illustrating the internal device 10 and protection device 20 (in particular, the MOS transistor 70) shown in FIG. 17.

The internal device 10 has the same structure as that employed in the first embodiment, therefore no description is given thereof. As shown in FIG. 18, in the protection device 20, a p-type well region 73 is formed in the surface of the semiconductor substrate 1. The well region 73 has the same depth as the n-type well region 11 and p-type well region 12 of the internal device 10. N⁺-type impurity diffusion layers 74 and 75 separate from each other are formed in the surface of the p-type well region 73. The n⁺-type impurity diffusion layers 74 and 75 function as the source and drain regions of the MOS transistor 70, respectively. A gage electrode 76 is provided on the p-type well 73 between the source and drain regions 74 and 75, with a gate insulation film (not shown) interposed.

The impurity concentration profile of the p-type well region 12 obtained in the direction of line 4E-4E in FIG. 18, and that of the p-type well region 73 obtained in the direction of line 4F-4F in FIG. 18 are similar to those of FIG. 4 related to the first embodiment. Specifically, the impurity concentration of the well region 73 incorporated in the protection device 20 is lower than that of the well region 12 incorporated in the internal device 10. More specifically, the concentration of the p-type impurity included in the well region 73 is lower than the concentration of the p-type impurity included in the well region 12. This can be said of the entire well regions 12 and 73 in the depth direction. In other words, this relationship is established both in surface portions of the well regions 12 and 73, and in deeper portions thereof. The relationship may be established between the well regions 11 and 73.

The operation of the protection device 20 formed as above will be described. When an ESD current flows into the semiconductor device from the input/output terminal, the potential at the node N1 instantly significantly increases. At this time, the gate potential of the MOS transistor 70 also increases because of the occurrence of coupling in the capacitor 71. In other words, the potential at the node N1 changes in synchrony with the gate potential of the MOS transistor 70. As a result, the MOS transistor 70 is turned on, thereby guiding the ESD current from the drain (node N1) to the source (ground). This prevents the ESD current from flowing into the internal device 10, and protects the internal device 10 from destruction due to the ESD current. This operation will be described in more detail. When the potential at the drain terminal (node N1) of the MOS transistor 70 exceeds the drain breakdown voltage, a drain avalanche breakdown current flows through the p-type well region 73. As a result, the source and drain regions 74 and 75 start to function as the collector and emitter of a parasitic npn bipolar transistor. This makes the collector current of the parasitic npn bipolar transistor prevailingly flow through the MOS transistor 70.

In the semiconductor device of the seventh embodiment, the internal device can be effectively protected from ESD, as in the fourth embodiment. This will be described in more detail, referring to FIG. 19. FIG. 19 is a graph useful in explaining the voltage (drain voltage VD)−current (drain current ID) characteristic of the MOS transistor 70 employed in the seventh embodiment.

The channel current of the MOS transistor is proportional to (Vg−Vt)² (Vg represents the gate voltage, and Vt represents the threshold voltage of the MOS transistor). When the threshold voltage Vt=Vd (Vd represents the drain voltage) exceeds the drain breakdown voltage BVD, the collector current of the parasitic npn bipolar transistor flows.

In this embodiment, the impurity concentrations of the well regions are reduced, therefore the trigger voltage lowers (Vt1<Vt2), the drain breakdown voltage increases (BVD1>BVD2), the resistance (i.e., ON-resistance) of-the parasitic npn bipolar transistor, assumed when this transistor is in the ON state, lowers, and the current amplification factor hfe of the parasitic npn bipolar transistor increases, compared to the conventional case. Accordingly, the degree of increase in drain current ID can be made higher than in the conventional case, as shown in FIG. 19. This reduces the clamp voltage Vclamp1. Therefore, even if the resistance of the internal device 10 to ESD is reduced in accordance with the development of microfabrication of semiconductor devices, the internal device 10 can be sufficiently protected from ESD.

In addition, for the same reason as stated in the first embodiment, the power generated by the MOS transistor 70 can be reduced. This enables the MOS transistor 70 to be made smaller than the conventional one, and hence enables the chip size to be reduced.

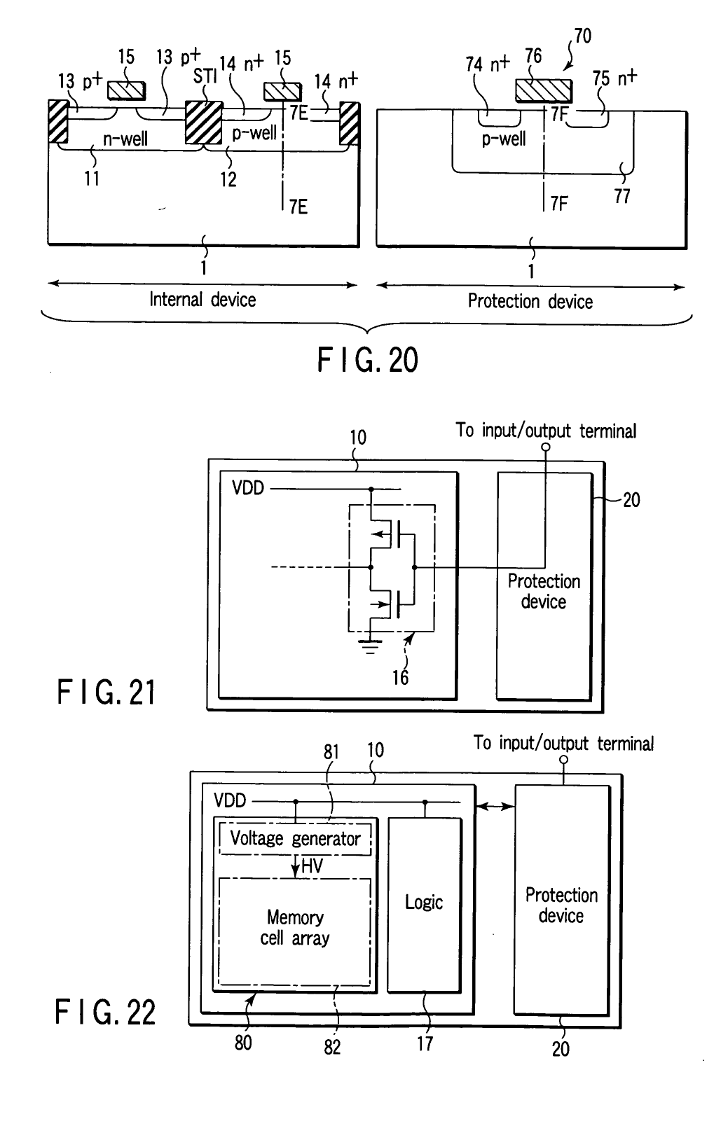

A semiconductor device according to an eighth embodiment will be described. The eighth embodiment differs from the seventh embodiment in that, in the former, the well regions in the protection device 20 are deeper than those in the internal device 10, with their impurity concentrations unchanged. Since the semiconductor device of the eighth embodiment has substantially the same circuit structure as the seventh embodiment shown in FIG. 17, no description is given thereof. FIG. 20 is a sectional view illustrating the internal device 10 and protection device 20 (in particular, the MOS transistor 70). Since the internal device 10 is similar to that of the seventh embodiment, only the MOS transistor 70 will be described.

As shown in FIG. 20, in the protection device 20, a p-type well region 77 is formed in the surface of the semiconductor substrate 1. The well region 77 is formed deeper than the n-type well region 11 and p-type well region 12 of the internal device 10. N⁺-type impurity diffusion layers 74 and 75 separate from each other are formed in the surface of the p-type well region 77. The n⁺-type impurity diffusion layers 74 and 75 function as the source and drain regions of the MOS transistor 70, respectively. A gate electrode 76 is formed on the p-type well 77 between the source and drain regions 74 and 75, with a gate insulation film (not shown) interposed.

The impurity concentration profile of the p-type well region 12 obtained in the direction of line 7E-7E in FIG. 20, and that of the p-type well region 77 obtained in the direction of line 7F-7F in FIG. 20 are similar to those of FIG. 7 related to the second embodiment. Specifically, the well region 77 in the protection device 20 has substantially the same impurity concentration as that of the well region 12 in the internal device 10, and is deeper than the region 12. This relationship may be established between the well regions 11 and 77.

The operation of the protection device 20 employed in the eighth embodiment is similar to that of the protection device 20 employed in the fourth embodiment, therefore no description is given thereof.

In the semiconductor device of the eighth embodiment, the protection device can effectively protect the internal device from ESD as in the fourth embodiment. This will be described in detail, referring to FIG. 19. FIG. 19 is a graph useful in explaining the voltage-current characteristic of the MOS transistor 70 employed in the seventh embodiment. The voltage (drain voltage VD)−current (drain current ID) characteristic of the MOS transistor 70 of the eighth embodiment is substantially the same as that of FIG. 19.

As mentioned above, the ON-resistance of the parasitic npn bipolar transistor is reduced by deeply forming the well region 77. This leads to reduction of the clamp voltage Vclamp1 as in the fourth embodiment. Therefore, even if the resistance of the internal device 10 to ESD is reduced in accordance with the development of microfabrication of semiconductor devices, the internal device 10 can be sufficiently protected from ESD.

Further, like the seventh embodiment, the size of the MOS transistor 70 can be made smaller than the conventional one, which contributes to the reduction of the chip size.

A semiconductor device according to a ninth embodiment will be described. This embodiment is obtained by combining the seventh and eighth embodiments. Since the semiconductor device of the ninth embodiment has the same circuit structure as the seventh embodiment shown in FIG. 17, no description is given thereof. Further, the semiconductor device of the sixth embodiment has the same cross section as the eighth embodiment shown in FIG. 20, and the impurity concentration profiles of the well regions in the internal device 10 and protection device 20 are similar to those of FIG. 10. The operation of the protection device 20 is also similar to that of the protection device 20 employed in the seventh embodiment.

In addition, for the same reason as stated in the seventh and eighth embodiments, the clamp voltage Vclamp1 is reduced. Accordingly, even if the resistance of the internal device 10 to ESD is reduced in accordance with the development of microfabrication of semiconductor devices, the internal device 10 can be sufficiently protected from ESD. Further, the size of the MOS transistor 70 can be made smaller than the conventional one, which contributes to the reduction of the chip size.

The relationship concerning the current-voltage characteristic, which is employed in the fourth to sixth embodiments and explained with reference to FIG. 16, is also established in the seventh to ninth embodiments. Therefore, also in the MOS transistors of the seventh to ninth embodiments, the breakdown current can be set larger than in the conventional case.

As described above, in the first to ninth embodiments of the invention, the impurity concentration of the entire well region of the protection device 20 in the depth direction, in and on which a protection element (thyrister, bipolar transistor, MOS transistor, etc.) is provided, is made lower than that of the well region of the to-be-protected internal device 10. Alternatively, the above-mentioned well region of the protection device 20 is made deeper than that of the internal device 10. Alternatively, the well region of the protection device 20 is made to have a lower impurity concentration than the well region of the internal device 10, and is made deeper than the letter well region. This being so, if a thyrister is used as the protection element, the trigger voltage and clamp voltage of the thyrister can be reduced. Further, if a bipolar transistor or MOS transistor is used as the protection element, the clamp voltage can also be reduced. Accordingly, even if the resistance of the internal device 10 to ESD is reduced in accordance with the development of microfabrication of semiconductor devices, the internal device 10 can be effectively protected from ESD.

In the conventional art, well regions of the same structure are provided in the internal device and protection device. Therefore, it is necessary to form the well regions in light of their characteristics. On the other hand, in the first to ninth embodiments of the invention, the well regions in the internal device 10 and protection device 20 have their impurity concentrations and/or depths determined independently. Therefore, the well regions of the circuits 10 and 20 can be formed under respective optimal conditions. As a result, the inner and protection devices can exhibit best performance, i.e., the protection device can protect the internal device regardless of whether the resistance of the internal device to ESD is reduced in accordance with the development of microfabrication of semiconductor devices.

Further, the first to ninth embodiments can be carried out at low cost simply by changing the conditions for implanting impurities into the semiconductor substrate.

In addition, a signal input to or output from the input/output terminal is generally passed through an input/output buffer 16 in the internal device, as is shown in FIG. 21. Accordingly, it is sufficient if the above-described relationship concerning the impurity concentration and depth is established between the well region(s) of the protection device 20 in and on which a protection element is formed, and the well region of the internal device 10 in and on which the input/output buffer 16 is formed. However, in the case as shown in FIG. 21 where the internal device 10 is powered by a single power voltage VDD, the semiconductor elements providing the internal device 10 are generally formed in and on well regions of the same structure. Therefore, the above-mentioned relationship may be established between all well regions of the internal device 10, and the well region(s) of the protection device 20 in and on which the protection element is provided. Further, since the trigger circuit 40 of the protection device 20 is not actually provided for preventing ESD, the well regions of the trigger circuit 40 may have the same structure as the well regions in the internal device 10. In other words, the above-mentioned relationship concerning the impurity concentration and depth may be established between the well region(s) of the protection element and those of the trigger circuit.

There is a case where the internal device is powered by a plurality of power supplies. FIG. 22 is a block diagram illustrating a system LSI that incorporates, for example, a flash memory. As shown, the internal device 10 comprises a logic circuit 17 and flash memory 80. The logic circuit 17 is powered by the power voltage VDD. The flash memory 80 includes a high-voltage generating circuit 81 that supplies a memory cell array 82 with a voltage HV higher than the voltage VDD. The high-voltage generating circuit 81 is provided because the flash memory 80 needs a high voltage for data writing and erasure. Since the flash memory 80 uses such a high voltage, the well regions of the flash memory 80 are generally made deeper than those of the logic circuit 17. Alternatively, the former well regions generally have a lower impurity concentration than the latter well regions. In this case, the well region(s) of the protection device 20 may have the same structure as those of the flash memory 80. If, however, a sufficient resistance to ESD cannot be obtained from the same well region structure as that of the flash memory 80, the well region(s) of the protection device 20 should be made deeper and/or to have a higher impurity concentration than those of the flash memory 80.

In the above-described embodiments, a thyrister, bipolar transistor or MOS transistor is used as the protection element. However, the protection element is not limited to these, but may be formed of another semiconductor element or a combination of semiconductor elements. In this case, it is sufficient if the above-described conditions concerning the well region impurity concentration and depth are satisfied in the element actually used to pass an ESD current therethrough.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device comprising:
an internal device including a first well region and a first semiconductor element formed in and/or on the first well; and
a protection device including a second well region and a second semiconductor element formed in and/or on the second well region, the second well region having a lower impurity concentration than the first well region, the protection device protecting the first semiconductor element.

2. The device according to claim 1, wherein:
the second semiconductor element includes a current path, the current path having one end connected to an external connection terminal and another end connected to a ground potential;
the first semiconductor element having an input/output terminal connected to the external connection terminal; and
the second semiconductor element guides, to the ground potential via the current path, a current flowing to the second semiconductor element from the external connection terminal, to prevent the first semiconductor element from being destroyed by the current.

3. The device according to claim 2, wherein a voltage occurring between the ends of the current path when the current flows into the second semiconductor element is less than a breakdown voltage of the first semiconductor element.

4. The device according to claim 2, wherein:
the protection device further includes a trigger circuit which starts an operation of the second semiconductor element;
the second semiconductor element is a thyrister or a bipolar transistor, the thyrister or the bipolar transistor having a control terminal connected to the trigger circuit; and
the trigger circuit supplies the control terminal of the second semiconductor element with an instruction to start the operation of the second semiconductor element, when the current flows from the external connection terminal to increase a potential at the input/output terminal, and when the potential at the input/output terminal is less than a breakdown voltage of the first semiconductor element.

5. The device according to claim 2, wherein:
the second semiconductor element is a MOS transistor; and
a gate potential of the MOS transistor changes in synchrony with a voltage at the one end of the current path.

6. The device according to claim 1, wherein an entire portion of the second well region in a depth direction has a lower impurity concentration than an entire portion of the first well region in the depth direction.

7. A semiconductor device comprising:
an internal device including a first well region and a first semiconductor element formed in and/or on the first well; and
a protection device including a second well region and a second semiconductor element formed in and/or on the second well region, the second well region having a greater depth than the first well region, the protection device protecting the first semiconductor element.

8. The device according to claim 7, wherein:
the second semiconductor element includes a current path, the current path having one end connected to an external connection terminal and another end connected to a ground potential;
the first semiconductor element having an input/output terminal connected to the external connection terminal; and
the second semiconductor element guides, to the ground potential via the current path, a current flowing to the second semiconductor element from the external connection terminal, to prevent the first semiconductor element from being destroyed by the current.

9. The device according to claim 8, wherein a voltage occurring between the ends of the current path when the current flows into the second semiconductor element is less than a breakdown voltage of the first semiconductor element.

10. The device according to claim 8, wherein:
the protection device further includes a trigger circuit which starts an operation of the second semiconductor element;
the second semiconductor element is a thyrister or a bipolar transistor, the thyrister or the bipolar transistor having a control terminal connected to the trigger circuit; and
the trigger circuit supplies the control terminal of the second semiconductor element with an instruction to start the operation of the second semiconductor element, when the current flows from the external connection terminal to increase a potential at the input/output terminal, and when the potential at the input/output terminal is less than a breakdown voltage of the first semiconductor element.

11. The device according to claim 8, wherein:
the second semiconductor element is a MOS transistor; and
a gate potential of the MOS transistor changes in synchrony with a voltage at the one end of the current path.

12. The device according to claim 7, wherein an entire portion of the second well region in a depth direction has a lower impurity concentration than an entire portion of the first well region in the depth direction.

13. A semiconductor device comprising:
an internal device including a first well region and a first semiconductor element formed in and/or on the first well; and
a protection device including a second well region and a second semiconductor element formed in and/or on the second well region, the second well region having a lower impurity concentration and having a greater depth than the first well region, the protection device protecting the first semiconductor element.

14. The device according to claim 13, wherein:
the second semiconductor element includes a current path, the current path having one end connected to an external connection terminal and another end connected to a ground potential;
the first semiconductor element having an input/output terminal connected to the external connection terminal; and
the second semiconductor element guides, to the ground potential via the current path, a current flowing to the second semiconductor element from the external connection terminal, to prevent the first semiconductor element from being destroyed by the current.

15. The device according to claim 14, wherein a voltage occurring between the ends of the current path when the current flows into the second semiconductor element is less than a breakdown voltage of the first semiconductor element.

16. The device according to claim 14, wherein:
the protection device further includes a trigger circuit which starts an operation of the second semiconductor element;
the second semiconductor element is a thyrister or a bipolar transistor, the thyrister or the bipolar transistor having a control terminal connected to the trigger circuit; and
the trigger circuit supplies the control terminal of the second semiconductor element with an instruction to start the operation of the second semiconductor element, when the current flows from the external connection terminal to increase a potential at the input/output terminal, and when the potential at the input/output terminal is less than a breakdown voltage of the first semiconductor element.

17. The device according to claim 14, wherein:
the second semiconductor element is a MOS transistor; and
a gate potential of the MOS transistor changes in synchrony with a voltage at the one end of the current path.

18. The device according to claim 13, wherein an entire portion of the second well region in a depth direction has a lower impurity concentration than an entire portion of the first well region in the depth direction.
